(19) United States
(12) Patent Application Publication
(10) Pub. No.: US 2025/0102986 A1
(43) Pub. Date: Mar. 27, 2025

(54) RECORDING-MEDIUM CONTAINER DEVICE AND IMAGE FORMING APPARATUS

(71) Applicant: FUJIFILM Business Innovation Corp., Tokyo (JP)

(72) Inventors: Ryosuke YONESAKA, Kanagawa (JP); Kazuhiko HORIKAWA, Kanagawa (JP); Yuichi ARAKI, Kanagawa (JP)

(73) Assignee: FUJIFILM Business Innovation Corp., Tokyo (JP)

(21) Appl. No.: 18/424,875

(22) Filed: Jan. 29, 2024

(30) Foreign Application Priority Data
Sep. 26, 2023 (JP) 2023-163632

(51) Int. Cl. G03G 15/00; B65H 3/48; B65H 7/16

(52) U.S. Cl. CPC G03G 15/6511; B65H 3/48; B65H 7/16; B65H 2406/10; G03G 2215/00556; G03G 2215/00721

(57) ABSTRACT

A recording-medium container device includes: a container that contains a recording-medium bundle in which multiple recording media are stacked; a blower that blows air onto the recording-medium bundle contained in the container; multiple light sources that radiate light beams having different wavelengths simultaneously onto at least one of the recording media separated from the recording-medium bundle by the air blown by the blower; and an image capturing unit that performs image-capturing of the at least one recording medium irradiated with the light beams from the multiple light sources, so as to acquire multiple captured images corresponding to the wavelengths of the light beams radiated from the light sources.

### CROSS-REFERENCE TO RELATED APPLICATIONS

This application is based on and claims priority under 35 USC 119 from Japanese Patent Application No. 2023-163632 filed Sep. 26, 2023.

### BACKGROUND

### (i) Technical Field

The present disclosure relates to recording-medium container devices and image forming apparatuses.

### (ii) Related Art

Japanese Unexamined Patent Application Publication No. 2016-52937 discloses a sheet feeding device that causes an upper sheet of a sheet bundle placed on a placement section to levitate by blowing air onto the sheet bundle and that ascertains the position of the sheet by capturing an image of the levitated sheet by using an image capturing unit. In this sheet feeding device, an irradiation unit irradiates the levitated sheet with light multiple times while the image capturing unit performs one exposure process.

### SUMMARY

In a device where a light source radiates light onto a recording medium separated from a recording-medium bundle by air blown thereto and that captures an image of the recording medium irradiated with the light, the recording medium may partially become a shadow or the recording medium may move irregularly due to the air depending on the relationship between the recording medium and the light source, sometimes making it difficult to clearly capture an image of the recording medium.

Aspects of non-limiting embodiments of the present disclosure relate to an ability to more clearly capture an image of a recording medium separated from a recording-medium bundle by air blown thereto, as compared with a case where the recording medium is irradiated multiple times with light beams having the same wavelength.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a recording-medium container device comprising: a container that contains a recording-medium bundle in which a plurality of recording media are stacked; a blower that blows air onto the recording-medium bundle contained in the container; a plurality of light sources that radiate light beams having different wavelengths simultaneously onto at least one of the recording media separated from the recording-medium bundle by the air blown by the blower; and an image capturing unit that performs image-capturing of the at least one recording medium irradiated with the light beams from the plurality of light sources, so as to acquire a plurality of captured images corresponding to the wavelengths of the light beams radiated from the light sources.

### BRIEF DESCRIPTION OF THE DRAWINGS

An exemplary embodiment of the present disclosure will be described in detail based on the following figures, wherein:

FIG. 1 schematically illustrates the configuration of an image forming apparatus according to an exemplary embodiment;

FIG. 2 is a cross-sectional view schematically illustrating the configuration of a container device, taken along line II-II in FIG. 1;

FIG. 3 illustrates the container device illustrated in FIG. 2, as viewed from a direction indicated by an arrow III;

FIG. 4 is a cross-sectional view illustrating an example of the configuration of an image capturing mechanism, taken along line IV-IV in FIG. 3;

FIG. 5 illustrates an example of a spectral distribution of light beams radiated from a first light source, a second light source, and a third light source;

FIGS. 6A to 6C illustrate an example of the configuration of an image capturing unit;

FIG. 7 illustrates an example of a spectral transmittance distribution of light beams from first filter sections, second filter sections, and third filter sections;

FIGS. 8A to 8C illustrate examples of captured images acquired by the image capturing unit; and

FIG. 9 is a flowchart illustrating an example of operation of the container device performed under control by a controller.

### DETAILED DESCRIPTION

An exemplary embodiment of the present disclosure will be described below with reference to the appended drawings.

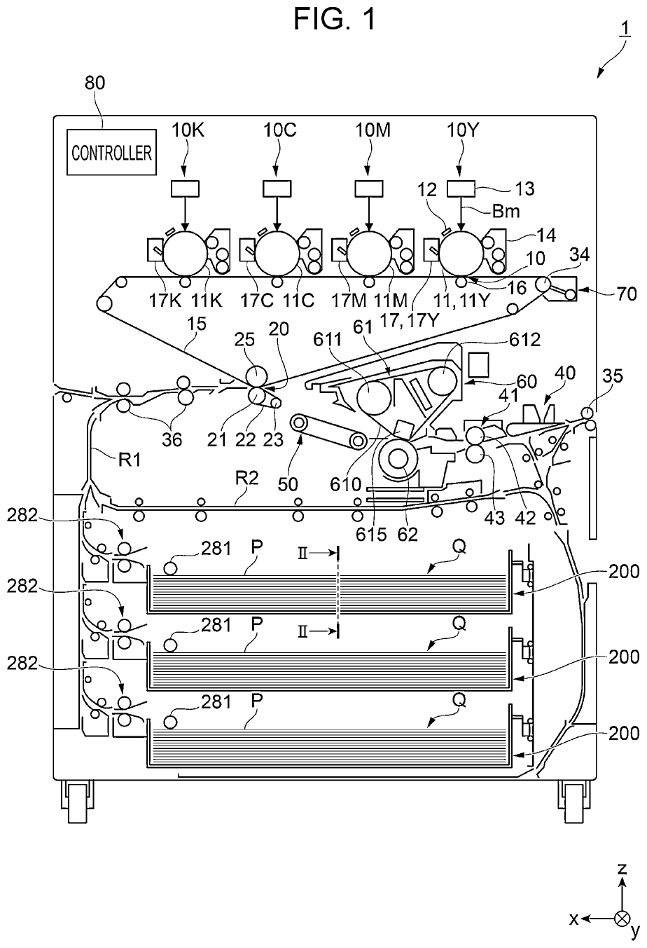

FIG. 1 schematically illustrates the configuration of an image forming apparatus 1 according to this exemplary embodiment.

The image forming apparatus 1 illustrated in FIG. 1 is of an intermediate transfer type, generally called a tandem type. In the following description, a direction extending from the right side toward the left side, a direction extending from the front side toward the rear side, and a direction extending from the lower side toward the upper side in FIG. 1 will be indicated as x direction, y direction, and z direction, respectively.

The image forming apparatus 1 is provided with multiple image forming units 10Y, 10M, 10C, and 10K that form toner images of respective color components by electrophotography. The image forming units 10Y, 10M, 10C, and 10K form yellow (Y), magenta (M), cyan (C), and black (K) images, respectively.

The image forming apparatus 1 is provided with first-transfer units 10 that sequentially first-transfer the color-component toner images formed by the image forming units 10Y, 10M, 10C, and 10K onto an intermediate transfer belt 15. The image forming apparatus 1 is also provided with a second-transfer unit 20 that collectively second-transfers the superposed toner images transferred on the intermediate transfer belt 15 onto a sheet P as an example of a recording medium.

Each of the image forming units 10Y, 10M, 10C, and 10K functioning as an example of image forming units is provided with the following electrophotographic devices. First, a photoconductor drum 11 that rotates clockwise in the drawing is surrounded by a charging device 12 that electrostatically charges the photoconductor drum 11. A laser exposure device 13 that writes an electrostatic latent image onto the photoconductor drum 11 is also provided. An exposure beam from the laser exposure device 13 is denoted by a reference sign Bm in FIG. 1. In the following description, the photoconductor drums 11 provided in the image forming units 10Y, 10M, 10C, and 10K may sometimes be indicated as photoconductor drums 11Y, 11M, 11C, and 11K.

Furthermore, a developing device 14 that accommodates a developer containing a carrier and a toner and turns the electrostatic latent image on the photoconductor drum 11 into a visible image by using the toner is provided. A first-transfer roller 16 that transfers the toner image of the corresponding color formed on the photoconductor drum 11 onto the intermediate transfer belt 15 at the first-transfer unit 10 is also provided. A drum cleaner 17 that removes the toner remaining on the photoconductor drum 11 is also provided. For example, the drum cleaner 17 is constituted of a cleaning blade that comes into contact with the surface of the photoconductor drum 11 to scrape off waste particles including the toner remaining on the surface of the photoconductor drum 11. In the following description, the drum cleaners 17 provided in the image forming units 10Y, 10M, 10C, and 10K may sometimes be indicated as drum cleaners 17Y, 17M, 17C, and 17K.

The intermediate transfer belt 15 circulates counterclockwise in FIG. 1 at a predetermined speed in accordance with a drive roller 34 driven by a motor (not illustrated). Each first-transfer unit 10 includes a first-transfer roller 16 disposed opposite thereto with the intermediate transfer belt 15 interposed therebetween. The toner images on the photoconductor drums 11 are electrostatically suctioned sequentially to the intermediate transfer belt 15, so that toner images superposed on the intermediate transfer belt 15 are formed.

The second-transfer unit 20 includes a second-transfer roller 21, a belt member 22, and a support roller 23 that are disposed on the outer periphery (i.e., on a toner-image bearing surface) of the intermediate transfer belt 15. The second-transfer unit 20 also includes a backup roller 25 disposed on the inner periphery of the intermediate transfer belt 15. In the second-transfer unit 20, the belt member 22 is wrapped around and supported by the outer peripheries of the second-transfer roller 21 and the support roller 23. Furthermore, in the second-transfer unit 20, the outer peripheral surface of the intermediate transfer belt 15 and the outer peripheral surface of the belt member 22 are disposed in contact with each other. Moreover, in the second-transfer unit 20, the second-transfer roller 21 is disposed to press against the backup roller 25 with the belt member 22 and the intermediate transfer belt 15 interposed therebetween. The second-transfer roller 21 is connected to ground, a second-transfer bias is formed between the second-transfer roller 21 and the backup roller 25, and the toner images formed on the intermediate transfer belt 15 are second-transferred onto the sheet P transported to the second-transfer unit 20.

The image forming apparatus 1 is also provided with a fixing device 60 as an example of a fixing unit that fixes the second-transferred toner images onto the sheet P.

The fixing device 60 includes a fixation belt module 61 and a pressure roller 62 pressed against the fixation belt module 61. In the fixing device 60, the sheet P is pressed and heated at a position (i.e., a fixation nip) where the fixation belt module 61 and the pressure roller 62 are in contact with each other, so that the toner images are fixed onto the sheet P.

The fixation belt module 61 includes an endless fixation belt 610 and rotatable support rollers 611 and 612 that support the fixation belt 610 from the inner side thereof. The support roller 611 rotates clockwise by receiving a driving force from a driving source (not illustrated). With the rotation of the support roller 611, the fixation belt 610 receives a driving force from the support roller 611 and revolves clockwise.

The fixation belt module 61 includes a load receiving member 615 that is positioned facing the pressure roller 62 with the fixation belt 610 interposed therebetween and that receives a load from the pressure roller 62. In the fixing device 60 according to this exemplary embodiment, the pressure roller 62 and the load receiving member 615 nip the sheet P from opposite sides and apply pressure to the sheet P.

Furthermore, the fixation belt module 61 is provided with a heater (not illustrated) that is disposed within the support rollers 611 and 612 and the load receiving member 615 and that heats the support rollers 611 and 612 and the load receiving member 615.

The image forming apparatus 1 also includes a transport member 50 that transports the sheet P having the toner images second-transferred thereon at the second-transfer unit 20 toward the fixing device 60.

The image forming apparatus 1 is also provided with a cleaning device 70 that cleans the surface of the intermediate transfer belt 15. The cleaning device 70 cleans off waste particles including the toners remaining on the surface of the intermediate transfer belt 15.

Moreover, the image forming apparatus 1 is provided with a transport roller pair 41 and a guide unit 40. The transport roller pair 41 is constituted of a pair of rotatable transport rollers 42 and 43 and transports the sheet P output from the fixing device 60 further downstream. The guide unit 40 guides the sheet P transported by the transport roller pair 41.

The image forming apparatus 1 is also provided with a sheet output unit 35 that outputs the sheet P passing through the guide unit 40 outward from the image forming apparatus 1.

Moreover, the image forming apparatus 1 is provided with a container device 200 as an example of a recording-medium container device. In this example, the image forming apparatus 1 is provided with three container devices 200 arranged in the z direction. The container devices 200 have identical structures. Each container device 200 contains a sheet bundle Q in which multiple sheets P are stacked. The sheet bundle Q is an example of a recording-medium bundle. The container device 200 separates a sheet P from the sheet bundle Q and feeds the sheet P to a transport path R1 to be described below.

The configuration of the container device 200 will be described in detail later.

The image forming apparatus 1 is also provided with the transport path R1 along which the sheet P is transported toward the sheet output unit 35 from the container device 200 via the second-transfer unit 20, the transport member 50, the fixing device 60, the transport roller pair 41, and the guide unit 40. Moreover, the image forming apparatus 1 is provided with a sheet inversion path R2 along which the sheet P having an image formed thereon and having passed through the transport roller pair 41 is transported toward the second-transfer unit 20 again after the front and rear faces of the sheet P are inverted.

The image forming apparatus 1 is further provided with a controller 80 that controls the operation of each unit of the image forming apparatus 1. The controller 80 includes a central processing unit (CPU), a read only memory (ROM), and a random access memory (RAM). The ROM stores a control program to be executed by the CPU. The CPU reads the control program stored in the ROM and executes the control program by using the RAM as a work area. When the control program is executed by the CPU, each unit of the image forming apparatus 1 is controlled.

The controller 80 according to this exemplary embodiment detects the position of the sheet P separated from the sheet bundle Q based on an image captured by an image capturing unit 250 of an image capturing mechanism 230 to be described later. Based on the detection result, an amount of air blown onto the sheet bundle Q by an air blowing mechanism 220 is adjusted. The controller 80 is an example of an adjuster.

A basic image forming process of the image forming apparatus 1 will now be described.

In the image forming apparatus 1, image data is output from an image reading device (not illustrated). The image data undergoes image processing performed by an image processing device (not illustrated) so as to be converted into colorant gradation data of four colors, namely, Y, M, C, and K colors, and is output to the laser exposure devices 13.

The laser exposure devices 13 irradiate the photoconductor drums 11 of the image forming units 10Y, 10M, 10C, and 10K with the exposure beams Bm emitted from, for example, semiconductor lasers in accordance with the input colorant gradation data. At each photoconductor drum 11, the surface thereof is electrostatically charged by the charging device 12 and subsequently undergoes a scanning exposure process performed by the laser exposure device 13, whereby an electrostatic latent image is formed. Then, after a toner image is formed on the photoconductor drum 11 by the developing device 14, the toner image is transferred onto the intermediate transfer belt 15 at the first-transfer unit 10 where the photoconductor drum 11 and the intermediate transfer belt 15 are in contact with each other.

After the toner image is first-transferred onto the surface of the intermediate transfer belt 15, the intermediate transfer belt 15 moves to transport the toner image to the second-transfer unit 20. At the second-transfer unit 20, the second-transfer roller 21 is pressed against the backup roller 25 via the belt member 22 and the intermediate transfer belt 15. In this case, the sheet P separated from the sheet bundle Q in the container device 200 and transported by, for example, a transport roller 36 is nipped between the intermediate transfer belt 15 and the belt member 22.

Then, the unfixed toner images retained on the intermediate transfer belt 15 are collectively electrostatically transferred onto the sheet P at the second-transfer unit 20. Subsequently, the sheet P having the toner images electrostatically transferred thereon is separated from the intermediate transfer belt 15 and is subsequently transported to the transport member 50 provided downstream of the second-transfer unit 20 in the sheet transport direction. Then, the sheet P transported to the transport member 50 is transported to the fixing device 60 by a transport belt 51.

The toner images on the sheet P transported to the fixing device 60 receive heat and pressure from the fixing device 60 so as to be fixed onto the sheet P. The sheet P having the fixed image formed thereon travels through the guide unit 40 by being transported by the transport roller pair 41, and is output outward from the image forming apparatus 1 via the sheet output unit 35.

On the other hand, the waste particles including the toners adhered on the photoconductor drums 11 after the first-transfer process are removed therefrom by the drum cleaners 17. Furthermore, the waste particles including the toners adhered on the intermediate transfer belt 15 after the second-transfer process are removed therefrom by the cleaning device 70.

Accordingly, the image forming process is repeatedly executed in the image forming apparatus 1 in cycles corresponding to the number of printed sheets.

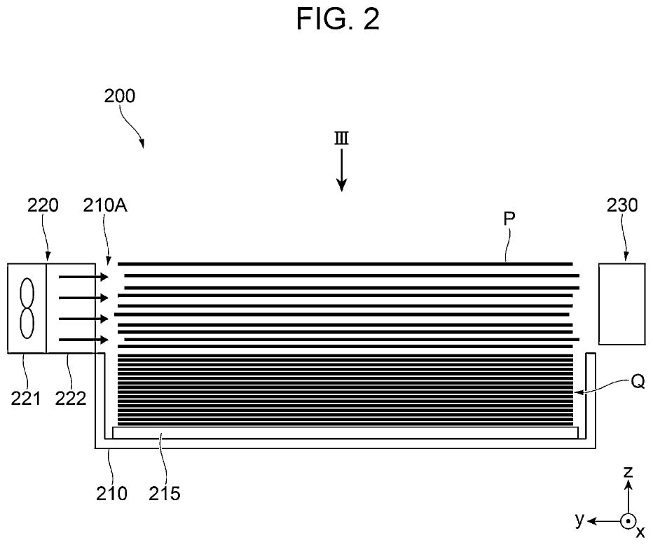

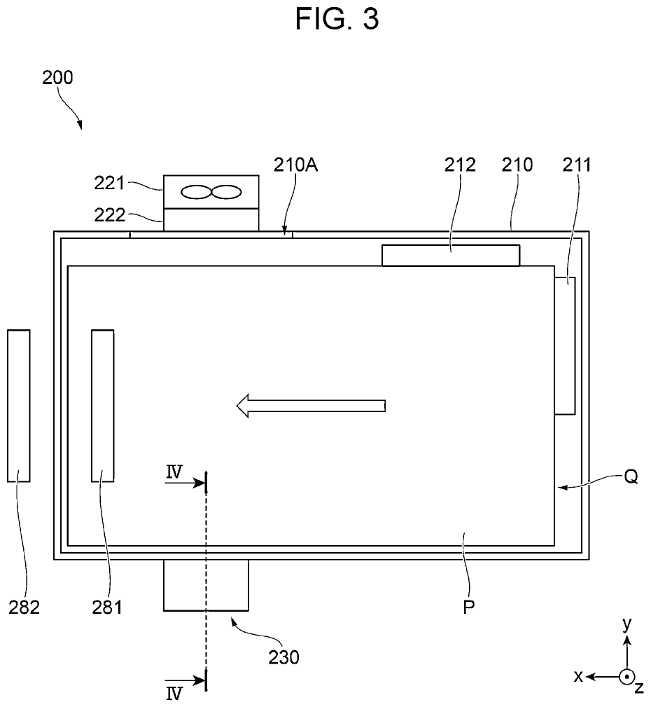

Next, the configuration of each container device 200 will be described. FIG. 2 is a cross-sectional view schematically illustrating the configuration of the container device 200, taken along line II-II in FIG. 1. FIG. 3 illustrates the container device 200 illustrated in FIG. 2, as viewed from a direction indicated by an arrow III.

The container device 200 includes a casing 210 as an example of a container that contains the sheet bundle Q. The container device 200 includes the air blowing mechanism 220 as an example of a blower that blows air toward the sheet bundle Q contained in the casing 210 to separate the sheet P from the sheet bundle Q. The container device 200 also includes the image capturing mechanism 230 that performs image-capturing of the sheet P separated from the sheet bundle Q by the air blowing mechanism 220. Moreover, the container device 200 includes a pickup roller 281 that retrieves the sheet P separated from the sheet bundle Q by the air blowing mechanism 220 from the casing 210, and a feed roller 282 that feeds the sheet P retrieved from the casing 210 by the pickup roller 281 toward the transport path R1.

The casing 210 has a rectangular-parallelepiped box shape with an upper opening (oriented downstream in the z direction). The casing 210 also has an opening 210A that is provided in the side surface facing the air blowing mechanism 220, that is, the side surface located downstream in the y direction, and through which the air from the air blowing mechanism 220 travels.

Furthermore, the casing 210 is provided with alignment members 211 and 212 that align the sheets P constituting the sheet bundle Q by coming into contact with peripheral edges of the sheet bundle Q. In this example, the alignment member 211 is provided upstream of the casing 210 in the x direction. The alignment member 211 comes into contact with a peripheral edge of the sheet bundle Q from the upstream side in the x direction, so as to align the sheets P constituting the sheet bundle Q in the x direction. The alignment member 212 is provided downstream of the casing 210 in the y direction. The alignment member 212 comes into contact with a peripheral edge of the sheet bundle Q from the downstream side in the y direction, so as to align the sheets P constituting the sheet bundle Q in the y direction.

The casing 210 is also provided with a load member 215 that is supported by the bottom surface of the casing 210 and on which the sheet bundle Q is loaded. The load member 215 is movable in the z direction by a driver (not illustrated). In other words, the load member 215 is moved in the z direction by the driver such that the z-direction position of the uppermost stacked sheet P in the sheet bundle Q is located at a predetermined position.

The air blowing mechanism 220 separates the sheet P from the sheet bundle Q by blowing air toward the sheet bundle Q contained in the casing 210. The air blowing mechanism 220 is provided facing the opening 210A provided in the side surface of the casing 210 located downstream in the y direction. The air blowing mechanism 220 has an air blowing member 221 that blows air, and a duct 222 that guides the air blown out from the air blowing member 221 into the casing 210.

The air blowing member 221 is, for example, a blower that blows high-pressure air by rotating a vane. The air blowing member 221 blows air upstream from the downstream side in the y direction. Although a detailed description will be provided later, in the air blowing mechanism 220 according to this exemplary embodiment, the amount of air blown out from the air blowing member 221 is adjusted in accordance with control by the controller 80.

The duct 222 is connected upstream of the air blowing member 221 in the y direction. The duct 222 guides the air blown out from the air blowing member 221 toward the sheet bundle Q contained in the casing 210. In other words, the duct 222 guides the air blown out from the air blowing member 221 downstream from the upstream side in the y direction.

The air blown upstream in the y direction from the air blowing member 221 of the air blowing mechanism 220 and guided by the duct 222 travels through the opening 210A in the casing 210 and is blown onto a peripheral edge of the sheet bundle Q contained in the casing 210. In other words, the air from the air blowing mechanism 220 is blown onto the downstream edge in the y direction among the peripheral edges of the sheet bundle Q.

Then, the air blown onto the sheet bundle Q contained in the casing 210 from the air blowing mechanism 220 causes multiple upper sheets P of the sheets P constituting the sheet bundle Q to levitate upward (i.e., downstream in the z direction). Accordingly, the multiple upper sheets P are separated from the sheet bundle Q.

When the sheets P are separated from the sheet bundle Q by the air from the air blowing mechanism 220, the uppermost sheet P is retrieved from the casing 210 by the pickup roller 281. The sheet P retrieved by the pickup roller 281 is fed to the transport path R1 by the feed roller 282. In this example, the sheet P is fed to the transport path R1 by being transported downstream in the x direction from the casing 210 by the feed roller 282.

In this exemplary embodiment, the pickup roller 281 and the feed roller 282 are an example of a transport unit that transports the sheet P separated from the sheet bundle Q.

The position, in the z direction, of the sheets P levitated by being separated from the sheet bundle Q varies depending on the amount of air blown onto the sheet bundle Q from the air blowing mechanism 220. In the following description, the position, in the z direction, of the sheets P levitated by being separated from the sheet bundle Q may sometimes be indicated as a levitated position of the sheets P.

The sheets P levitated by being separated from the sheet bundle Q descend when the amount of air blown out from the air blowing mechanism 220 decreases. Accordingly, the levitated position of the sheets P becomes lower, so that the distance between the sheets P levitated by being separated from the sheet bundle Q decreases.

The sheets P levitated by being separated from the sheet bundle Q levitate further when the amount of air blown out from the air blowing mechanism 220 increases. Accordingly, the levitated position of the sheets P becomes higher, so that the distance between the sheets P levitated by being separated from the sheet bundle Q increases.

On the other hand, when the amount of air blown out from the air blowing mechanism 220 further increases, the sheets P levitated by being separated from the sheet bundle Q abut on, for example, the pickup roller 281 provided above the casing 210 or a housing (not illustrated) of the container device 200, and become incapable of levitating any further. The multiple upper sheets P of the sheets P levitated by being separated from the sheet bundle Q may sometimes overlie each other to become a bundle.

The air blowing mechanism 220 according to this exemplary embodiment adjusts the amount of air blown out from the air blowing member 221 based on control by the controller 80. In other words, the air blowing mechanism 220 adjusts the amount of air blown out from the air blowing member 221 such that the sheets P separated from the sheet bundle Q are in a predetermined normal state. In this case, the term “normal state” refers to a state where the uppermost sheet P of the sheets P separated from the sheet bundle Q is retrievable from the casing 210 by the pickup roller 281 so as to be properly feedable to the transport path R1 by the feed roller 282. An example of such a normal state is a state where the levitated position of the sheets P separated from the sheet bundle Q or the distance between the sheets P is within a predetermined range such that the multiple levitated upper sheets P do not overlie each other to form a bundle.

The controller 80 adjusts the amount of air blown out from the air blowing member 221 based on a captured image, obtained by the image capturing mechanism 230, of the sheets P separated from the sheet bundle Q.

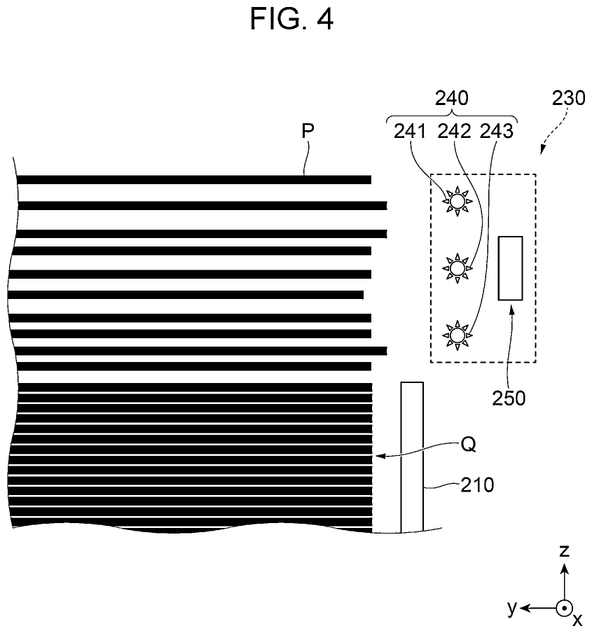

As mentioned above, the image capturing mechanism 230 performs image-capturing of the sheets P separated from the sheet bundle Q by the air blowing mechanism 220. FIG. 4 is a cross-sectional view illustrating an example of the configuration of the image capturing mechanism 230, as taken along line IV-IV in FIG. 3.

The image capturing mechanism 230 is provided facing the sheets P, separated from the sheet bundle Q contained in the casing 210, from the upstream side in the x direction. The image capturing mechanism 230 includes a light source 240 that radiates light toward the sheets P separated from the sheet bundle Q by the air blowing mechanism 220. The image capturing mechanism 230 also includes the image capturing unit 250 that acquires a captured image by performing image-capturing of the sheets P irradiated with the light from the light source 240.

The light source 240 includes a first light source 241, a second light source 242, and a third light source 243 as an example of multiple light sources. The first light source 241, the second light source 242, and the third light source 243 are arranged at a predetermined pitch in the z direction serving as a stacking direction of the sheets P in the sheet bundle Q. In this example, the first light source 241, the second light source 242, and the third light source 243 are arranged at an equal pitch from the downstream side toward the upstream side in the z direction (i.e., from the upper side toward the lower side in FIG. 4).

The first light source 241, the second light source 242, and the third light source 243 radiate light beams toward a peripheral edge of the sheets P separated from the sheet bundle Q. In other words, the first light source 241, the second light source 242, and the third light source 243 radiate light beams toward the upstream edge in the x direction among the peripheral edges of the sheets P.

In the light source 240 according to this exemplary embodiment, the first light source 241, the second light source 242, and the third light source 243 are disposed at different locations in the z direction. Accordingly, the first light source 241, the second light source 242, and the third light source 243 irradiate the peripheral edge of the sheets P separated from the sheet bundle Q with light beams from different locations in the z direction.

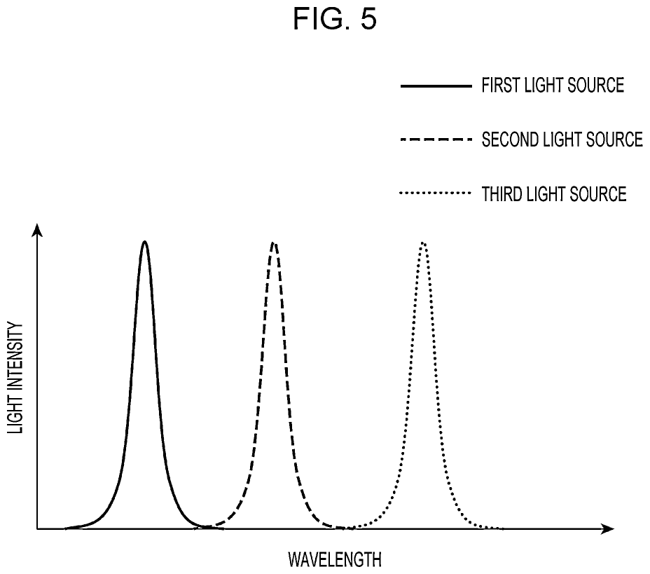

FIG. 5 illustrates an example of a spectral distribution of the light beams radiated from the first light source 241, the second light source 242, and the third light source 243. In FIG. 5, the abscissa axis denotes the wavelength of each of the light beams radiated from the first light source 241, the second light source 242, and the third light source 243, whereas the ordinate axis denotes the intensity of each light beam.

In the light source 240 according to this exemplary embodiment, the first light source 241, the second light source 242, and the third light source 243 radiate light beams with different wavelengths onto the sheets P separated from the sheet bundle Q. In detail, as illustrated in FIG. 5, each of the first light source 241, the second light source 242, and the third light source 243 irradiates the sheets P separated from the sheet bundle Q with light having a single peak wavelength in the spectral distribution.

The first light source 241 is an example of a blue light source that radiates blue (B) light having a peak wavelength within a range between 460 nm and 500 nm inclusive. For example, the first light source 241 is a blue light emitting diode (LED) that radiates blue light.

The second light source 242 is an example of a green light source that radiates green (G) light having a peak wavelength within a range between 500 nm and 570 nm inclusive. For example, the second light source 242 is a green LED that radiates green light.

The third light source 243 is an example of a red light source that radiates red (R) light having a peak wavelength within a range between 610 nm and 780 nm inclusive. For example, the third light source 243 is a red LED that radiates red light.

The light source 240 turns on the first light source 241, the second light source 242, and the third light source 243 by being controlled by the controller 80, so as to radiate light beams from the first light source 241, the second light source 242, and the third light source 243 onto the peripheral edge of the sheets P separated from the sheet bundle Q.

In this exemplary embodiment, the light source 240 turns on the first light source 241, the second light source 242, and the third light source 243 simultaneously. Accordingly, the light source 240 radiates light beams with different wavelengths simultaneously onto the peripheral edge of the sheets P separated from the sheet bundle Q. In detail, the light source 240 simultaneously radiates a blue light beam from the first light source 241, a green light beam from the second light source 242, and a red light beam from the third light source 243.

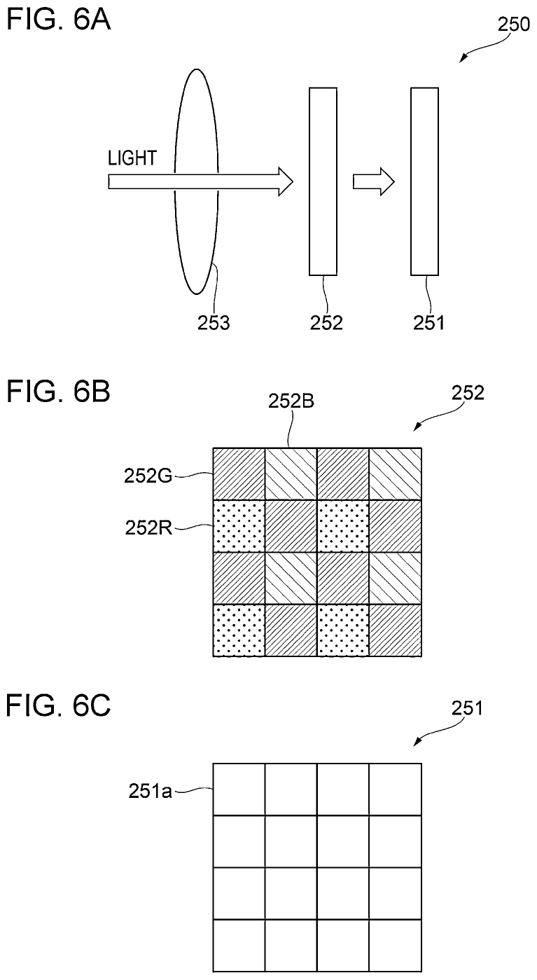

FIGS. 6A to 6C illustrate an example of the configuration of the image capturing unit 250. FIG. 6A illustrates the image capturing unit 250, as viewed from the downstream side in the x direction. FIG. 6B illustrates a color filter 252, to be described later, as viewed from the downstream side in the y direction. FIG. 6C illustrates an imaging element 251, to be described later, as viewed from the downstream side in the y direction.

The image capturing unit 250 includes the imaging element 251 having multiple pixels 251a that are arranged in a matrix. Each pixel 251a outputs an image signal in accordance with the amount of light received. In the imaging element 251 in this example, the multiple pixels 251a are arranged in the vertical direction (z direction) and the horizontal direction (x direction). Each pixel 251a in the imaging element 251 receives light passing through the color filter 252 and outputs an image signal in accordance with the amount of light received. The image capturing unit 250 acquires a captured image based on the image signals output from the pixels 251a of the imaging element 251.

The image capturing unit 250 according to this exemplary embodiment is a so-called single-plate color camera that captures an image using a single imaging element 251.

The image capturing unit 250 includes the color filter 252 including first filter sections 252B as an example of blue transmission sections that transmit blue (B) light, second filter sections 252G as an example of green transmission sections that transmit green (G) light, and third filter sections 252R as an example of red transmission sections that transmit red (R) light. The color filter 252 has a so-called Bayer layout where a column in which the first filter sections 252B and the second filter sections 252G are alternately arranged in the vertical direction (z direction) and a column in which the second filter sections 252G and the third filter sections 252R are alternately arranged in the vertical direction (z direction) are alternately arranged in the horizontal direction (x direction). The first filter sections 252B, the second filter sections 252G, and the third filter sections 252R constituting the color filter 252 are provided in alignment with the pixels 251a of the imaging element 251.

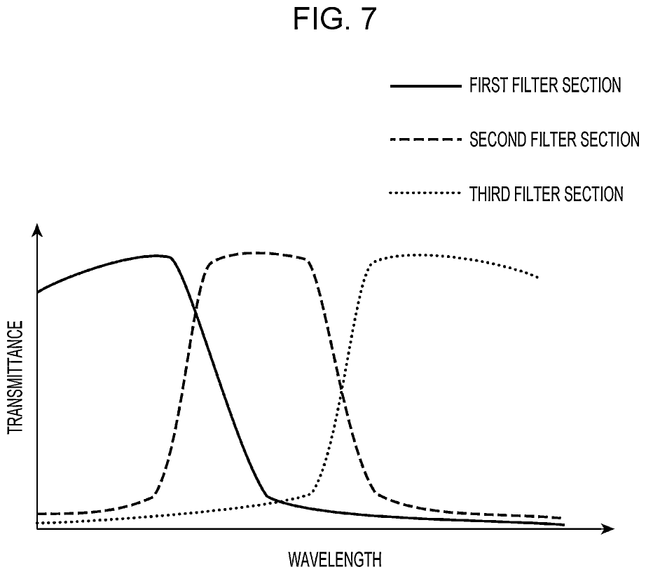

FIG. 7 illustrates an example of a spectral transmittance distribution of light beams from the first filter sections 252B, the second filter sections 252G, and the third filter sections 252R. In FIG. 7, the abscissa axis denotes the wavelength of each of the light beams transmitted through the first filter sections 252B, the second filter sections 252G, and the third filter sections 252R, whereas the ordinate axis denotes the transmittance of each light beam.

The first filter sections 252B transmit the light radiated from the first light source 241. In other words, the first filter sections 252B has high transmittance with respect to the wavelength of the light radiated from the first light source 241. On the other hand, in the first filter sections 252B, the transmittance with respect to the wavelength of the light radiated from each of the second light source 242 and the third light source 243 is lower than the transmittance with respect to the wavelength of the light radiated from the first light source 241. In this example, in the first filter sections 252B, the transmittance with respect to the wavelength of the light radiated from each of the second light source 242 and the third light source 243 is lower than 1/10 of the transmittance with respect to the wavelength of the light radiated from the first light source 241.

Likewise, the second filter sections 252G transmit the light radiated from the second light source 242. In other words, the second filter sections 252G has high transmittance with respect to the wavelength of the light radiated from the second light source 242. On the other hand, in the second filter sections 252G, the transmittance with respect to the wavelength of the light radiated from each of the first light source 241 and the third light source 243 is lower than the transmittance with respect to the wavelength of the light radiated from the second light source 242. In this example, in the second filter sections 252G, the transmittance with respect to the wavelength of the light radiated from each of the first light source 241 and the third light source 243 is lower than 1/10 of the transmittance with respect to the wavelength of the light radiated from the second light source 242.

Likewise, the third filter sections 252R transmit the light radiated from the third light source 243. In other words, the third filter sections 252R has high transmittance with respect to the wavelength of the light radiated from the third light source 243. On the other hand, in the third filter sections 252R, the transmittance with respect to the wavelength of the light radiated from each of the first light source 241 and the second light source 242 is lower than the transmittance with respect to the wavelength of the light radiated from the third light source 243. In this example, in the third filter sections 252R, the transmittance with respect to the wavelength of the light radiated from each of the first light source 241 and the second light source 242 is lower than 1/10 of the transmittance with respect to the wavelength of the light radiated from the third light source 243.

Furthermore, the image capturing unit 250 includes a lens 253 that focuses the light from the sheets P separated from the sheet bundle Q onto the imaging element 251.

The image capturing unit 250 causes the imaging element 251 to perform image-capturing of the sheets P separated from the sheet bundle Q based on control by the controller 80, so as to acquire a captured image. In detail, after the air blowing mechanism 220 starts to blow air to separate the sheets P from the sheet bundle Q, the image capturing unit 250 causes the imaging element 251 to perform an exposure process, thereby acquiring a captured image of the sheets P.

As mentioned above, the light source 240 turns on the first light source 241, the second light source 242, and the third light source 243 simultaneously by being controlled by the controller 80. In this exemplary embodiment, the light source 240 turns on the first light source 241, the second light source 242, and the third light source 243 simultaneously during the exposure period of the imaging element 251 in the image capturing unit 250. Accordingly, during the exposure period of the imaging element 251 in the image capturing unit 250, the light source 240 simultaneously radiates the peripheral edge of the sheets P separated from the sheet bundle Q with the blue light from the first light source 241, the green light from the second light source 242, and the red light from the third light source 243.

In this exemplary embodiment, the simultaneous irradiation of the sheets P with the blue light from the first light source 241, the green light from the second light source 242, and the red light from the third light source 243 implies that the exposure period of the imaging element 251 includes a period in which the first light source 241, the second light source 242, and the third light source 243 are simultaneously turned on. In other words, the start or end timing for turning on the first light source 241, the second light source 242, and the third light source 243 may be different from one another so long as the exposure period of the imaging element 251 includes the period in which the first light source 241, the second light source 242, and the third light source 243 are simultaneously turned on.

The imaging element 251 acquires captured images of the sheets P simultaneously irradiated with the blue light from the first light source 241, the green light from the second light source 242, and the red light from the third light source 243.

The imaging element 251 uses the pixels 251a aligned with the first filter sections 252B of the color filter 252 to receive the light transmitted through the first filter sections 252B. Moreover, the imaging element 251 uses the pixels 251a aligned with the first filter sections 252B to acquire a captured image of the sheets P irradiated with the blue light from the first light source 241.

The imaging element 251 uses the pixels 251a aligned with the second filter sections 252G of the color filter 252 to receive the light transmitted through the second filter sections 252G. Moreover, the imaging element 251 uses the pixels 251a aligned with the second filter sections 252G to acquire a captured image of the sheets P irradiated with the green light from the second light source 242.

The imaging element 251 uses the pixels 251a aligned with the third filter sections 252R of the color filter 252 to receive the light transmitted through the third filter sections 252R. Moreover, the imaging element 251 uses the pixels 251a aligned with the third filter sections 252R to acquire a captured image of the sheets P irradiated with the red light from the third light source 243.

Accordingly, the image capturing unit 250 according this exemplary embodiment acquires the multiple captured images of the sheets P corresponding to the wavelengths of the light beams radiated from the first light source 241, the second light source 242, and the third light source 243. In further detail, the image capturing unit 250 acquires the captured image of the sheets P corresponding to the wavelength of the blue light radiated from the first light source 241, the captured image of the sheets P corresponding to the wavelength of the green light radiated from the second light source 242, and the captured image of the sheets P corresponding to the wavelength of the red light radiated from the third light source 243. The image capturing unit 250 outputs the multiple acquired captured images to the controller 80. The controller 80 ascertains the state of the sheets P separated from the sheet bundle Q based on the acquired captured images, and adjusts the amount of air blown out from the air blowing member 221 of the air blowing mechanism 220 based on the state of the sheets P.

When the sheets P separated from the sheet bundle Q by the air blown out from the air blowing mechanism 220 are to be irradiated with light from a light source and a captured image is to be acquired by performing image-capturing of the sheets P irradiated with the light, it may sometimes be difficult to clearly capture an image of the sheets P. In other words, the sheets P may partially become a shadow or the sheets P may move irregularly due to the air from the air blowing mechanism 220 depending on the positional relationship between the sheets P and the light source, sometimes making it difficult to clearly capture an image of the sheets P.

When the sheets P separated from the sheet bundle Q are to be irradiated with light from a single light source, a sheet P located away from the light source is less likely to be irradiated with the light. For example, if the single light source is located at the position of the second light source 242 in FIG. 4, the sheets P located at the upper side (i.e., the downstream side in the z direction) and the lower side (i.e., the upstream side in the z direction) are less likely to be irradiated with the light. This may cause the sheets P to be shadow images in the captured image, thus resulting in unclear images of the sheets P.

From the standpoint of suppressing shadow images of the sheets P in the captured image, it is conceivable to irradiate the sheets P multiple times with light beams having the same wavelength by using multiple light sources arranged in the stacking direction of the sheets P. In this case, when the multiple light sources are sequentially turned on, the sheets P may move irregularly due to the air from the air blowing mechanism 220 depending on the timings at which the sheets P are irradiated with the light beams from the respective light sources, sometimes resulting in positional deviation among the sheets P. In this case, image blurring tends to occur in the sheets P in the captured image, resulting in unclear images of the sheets P.

When the images of the sheets P separated from the sheet bundle Q are unclear in the captured image, it becomes difficult for the controller 80 to detect the levitated position of the sheets P or the existence of a bundle of multiple levitated sheets P based on the captured image.

In contrast, in the image capturing mechanism 230 according to this exemplary embodiment, the sheets P separated from the sheet bundle Q by the air blown from the air blowing mechanism 220 are simultaneously irradiated with light beams having different wavelengths from the first light source 241, the second light source 242, and the third light source 243 of the light source 240, as mentioned above. The image capturing unit 250 performs image-capturing of the sheets P irradiated with the light beams from the light source 240, so as to acquire multiple captured images corresponding to the wavelengths of the light beams radiated from the first light source 241, the second light source 242, and the third light source 243.

Accordingly, the sheets P separated from the sheet bundle Q may be image-captured more clearly.

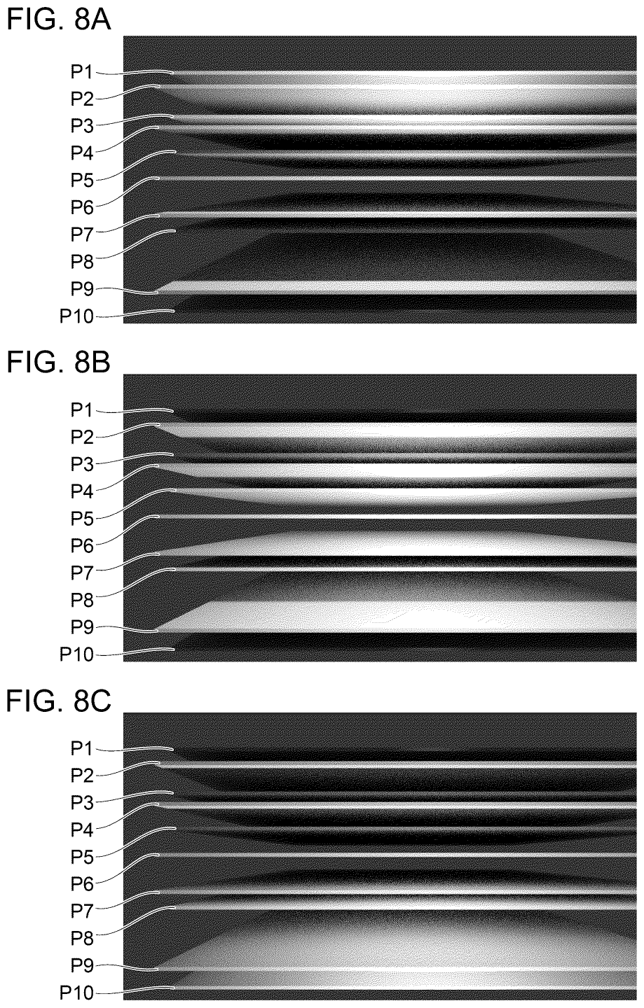

FIGS. 8A to 8C illustrate examples of captured images acquired by the image capturing unit 250. FIG. 8A illustrates a captured image of the sheets P irradiated with the blue light from the first light source 241. This captured image is acquired by the pixels 251a aligned with the first filter sections 252B of the color filter 252. FIG. 8B illustrates a captured image of the sheets P irradiated with the green light from the second light source 242. This captured image is acquired by the pixels 251a aligned with the second filter sections 252G of the color filter 252. FIG. 8C illustrates a captured image of the sheets P irradiated with the red light from the third light source 243. This captured image is acquired by the pixels 215a aligned with the third filter sections 252R of the color filter 252. The captured image illustrated in FIG. 8A, the captured image illustrated in FIG. 8B, and the captured image illustrated in FIG. 8C may be indicated as a blue captured image, a green captured image, and a red captured image, respectively.

Each of the captured images illustrated in FIGS. 8A to 8C shows 10 images of the sheets P as the sheets P separated from the sheet bundle Q by the air from the air blowing mechanism 220. As mentioned above, the image capturing mechanism 230 is provided facing the sheets P, separated from the sheet bundle Q contained in the casing 210, from the upstream side in the x direction. Therefore, each captured image shows, as an image of each sheet P, an image of an edge located upstream in the x direction among the peripheral edges of the sheet P. The edge images of the sheets P illustrated in FIGS. 8A to 8C are indicated as sheets P1, P2, . . . , and P10 in that order from the upper side in FIGS. 8A to 8C.

As illustrated in FIGS. 8A to 8C, the positions of the sheets P1 to P10 in the captured images are the same among the blue captured image in FIG. 8A, the green captured image in FIG. 8B, and the red captured image in FIG. 8C. This is because the first light source 241, the second light source 242, and the third light source 243 of the light source 240 simultaneously radiate light beams having different wavelengths so that the blue captured image, the green captured image, and the red captured image are simultaneously acquired.

The lowermost sheet P10 is a shadow and is unclear in the blue captured image illustrated in FIG. 8A and the green captured image illustrated in FIG. 8B, whereas the sheet P10 is clearly shown in the red captured image illustrated in FIG. 8C.

The uppermost sheet P1 is a shadow and is unclear in the green captured image illustrated in FIG. 8B and the red captured image illustrated in FIG. 8C, whereas the sheet P1 is clearly shown in the blue captured image illustrated in FIG. 8A.

Specifically, the 10 sheets P1 to P10 separated from the sheet bundle Q are clearly shown in at least one of the blue captured image in FIG. 8A, the green captured image in FIG. 8B, and the red captured image in FIG. 8C. In other words, there is no sheet P that is not shown in any of the blue captured image in FIG. 8A, the green captured image in FIG. 8B, and the red captured image in FIG. 8C.

Accordingly, in this exemplary embodiment, the sheets P separated from the sheet bundle Q are shown in at least one of the multiple captured images captured by the image capturing unit 250, so that the controller 80 may readily ascertain the levitated position of the sheets P separated from the sheet bundle Q or the state of the sheets P based on the captured image. Then, the controller 80 adjusts the amount of air blown out from the air blowing member 221 based on the state of the sheets P separated from the sheet bundle Q, whereby the sheets P separated from the sheet bundle Q may be readily guided to the normal state.

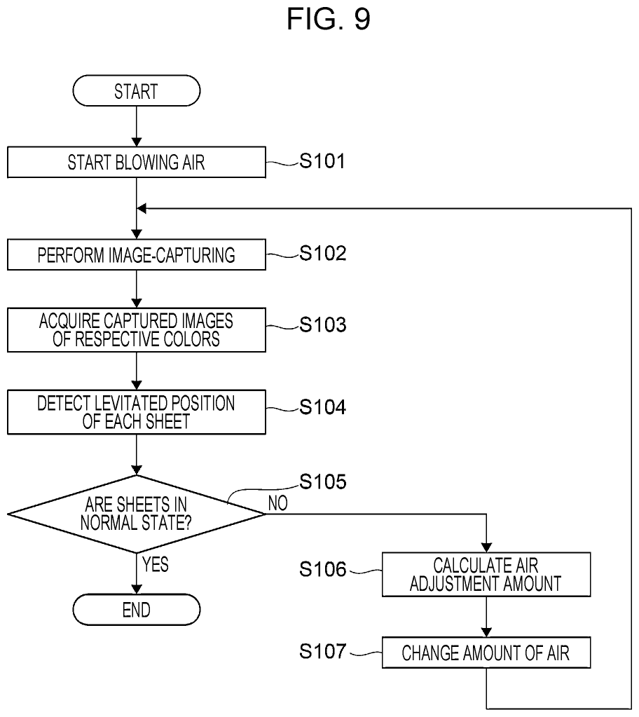

Next, the operation of the container device 200 according to this exemplary embodiment performed in accordance with control of the controller 80 will be described. FIG. 9 is a flowchart illustrating an example of the operation of the container device 200 performed in accordance with the control of the controller 80.

When the image forming apparatus 1 receives a command for forming an image onto a sheet P from, for example, a user, the controller 80 causes the air blowing mechanism 220 to start blowing air in step S101. In detail, the controller 80 drives the air blowing member 221 of the air blowing mechanism 220 to cause the air blowing member 221 to blow a predetermined amount of air. The air from the air blowing member 221 is blown onto the sheet bundle Q contained in the casing 210 so that multiple upper sheets P are separated from the sheet bundle Q.

In step S102, the controller 80 causes the image capturing mechanism 230 to perform image-capturing of the sheets P separated from the sheet bundle Q. In detail, the controller 80 causes the light source 240 of the image capturing mechanism 230 to simultaneously radiate light beams having different wavelengths onto the sheets P separated from the sheet bundle Q. Moreover, the controller 80 causes the image capturing unit 250 of the image capturing mechanism 230 to perform image-capturing of the sheets P irradiated with the light beams from the light source 240.

As mentioned above, in this exemplary embodiment, the controller 80 causes the first light source 241, the second light source 242, and the third light source 243 of the light source 240 to simultaneously radiate the blue light beam, the green light beam, and the red light beam, respectively, during the exposure period of the imaging element 251 in the image capturing unit 250.

In step S103, the controller 80 acquires captured images of the respective colors captured by the image capturing unit 250 of the image capturing mechanism 230. In this example, the controller 80 acquires the blue captured image illustrated in FIG. 8A, the green captured image illustrated in FIG. 8B, and the red captured image illustrated in FIG. 8C as the captured images of the respective colors.

In step S104, the controller 80 detects the levitated position of the sheets P separated from the sheet bundle Q based on the captured images of the respective colors acquired in step S103. In this example, the controller 80 detects the levitated position of each of the 10 sheets P1 to P10 shown in the captured images.

As mentioned above, in this exemplary embodiment, each of the sheets P1 to P10 is shown in at least one of the blue captured image, the green captured image, and the red captured image. Therefore, the controller 80 may detect the levitated position of each of the sheets P1 to P10 by using the captured image that clearly shows each of the sheets P1 to P10.

If each sheet P is shown in multiple captured images, the controller 80 may detect the levitated position of the sheet P based on a captured image in which the sheet P shown therein is the thinnest among the multiple captured images. Accordingly, the levitated position of the sheet P may be obtained more accurately, as compared with a case where the levitated position of the sheet P is detected based on a captured image in which the sheet P shown therein is the thickest.

For example, in each of the blue captured image in FIG. 8A, the green captured image in FIG. 8B, and the red captured image in FIG. 8C, the ninth sheet P9 from the top is clearly shown. The thickness of the sheet P9 shown in the blue captured image in FIG. 8A is smaller than the thickness of the sheet P9 shown in each of the green captured image in FIG. 8B and the red captured image in FIG. 8C. In this case, the controller 80 may detect the levitated position of the sheet P9 based on the blue captured image in FIG. 8A.

Referring back to FIG. 9, in step S105, the controller 80 determines whether or not the sheets P separated from the sheet bundle Q are in the predetermined normal state based on the levitated position of each sheet P detected in step S104.

For example, if the levitated position of the uppermost sheet P1 among the sheets P separated from the sheet bundle Q is higher than or lower than a predetermined range, the controller 80 determines that the sheets P are not in the normal state. If the distance between the sheets P is larger than or smaller than a predetermined distance, the controller 80 determines that the sheets P are not in the normal state. If multiple levitated sheets P overlie each other to form a bundle, the controller 80 determines that the sheets P are not in the normal state.

If it is determined that the sheets P separated from the sheet bundle Q are not in the normal state (NO in step S105), the controller 80 calculates an adjustment amount (referred to as “air adjustment amount” hereinafter) for adjusting the amount of air blown out from the air blowing member 221 in step S106. In other words, the controller 80 calculates the air adjustment amount in accordance with the state of the sheets P separated from the sheet bundle Q. For example, if the levitated position of the sheet P1 separated from the sheet bundle Q is higher than the predetermined range, if the distance between the sheets P is larger than the predetermined distance, and if multiple levitated sheets P overlie each other to form a bundle, the controller 80 calculates the air adjustment amount such that the amount of air blown out from the air blowing member 221 decreases. Furthermore, if the levitated position of the sheet Pl separated from the sheet bundle Q is lower than the predetermined range and if the distance between the sheets P is smaller than the predetermined distance, the controller 80 calculates the air adjustment amount such that the amount of air blown out from the air blowing member 221 increases.

In step S107, the controller 80 changes the amount of air blown out from the air blowing member 221 of the air blowing mechanism 220 based on the air adjustment amount calculated in step S106. Accordingly, the amount of air blown onto the sheet bundle Q contained in the casing 210 is changed, so that the state of the sheets P separated from the sheet bundle Q by the air from the air blowing mechanism 220 approaches the normal state.

Subsequently, the controller 80 returns to step $102 to continue with the process.

In contrast, if it is determined in step S105 that the sheets P separated from the sheet bundle Q are in the normal state (YES in step S105), the controller 80 ends the process.

As described above, the container device 200 according to this exemplary embodiment irradiates the sheets P separated from the sheet bundle Q by the air blown out from the air blowing mechanism 220 simultaneously with light beams having different wavelengths from the first light source 241, the second light source 242, and the third light source 243. Then, the image capturing unit 250 performs image-capturing of the sheets P to acquire multiple captured images corresponding to the wavelengths of the light beams radiated from the first light source 241, the second light source 242, and the third light source 243.

Accordingly, the container device 200 according to this exemplary embodiment may obtain captured images that express the sheets P more clearly, as compared with a case where, for example, the images of the sheets P are captured by irradiating the sheets P multiple times with light beams having the same wavelength.

Furthermore, the image forming apparatus 1 according to this exemplary embodiment equipped with the container device 200 includes the controller 80 that uses the captured images acquired by the image capturing unit 250 to detect the position of an edge of the sheets P separated from the sheet bundle Q. The controller 80 adjusts the amount of air blown onto the sheets P from the air blowing mechanism 220 based on the detection result of the position of the edge of the sheets P.

Accordingly, the sheets P separated from the sheet bundle Q may be readily guided to the normal state suitable for transporting the sheets P along the transport path R1 from the casing 210 by the pickup roller 281 and the feed roller 282.

In the above exemplary embodiment, a single-plate color camera equipped with a single imaging element 251 having a Bayer layout is described as an example of the image capturing unit 250 of the image capturing mechanism 230. However, the image capturing unit 250 is not limited to a single-plate color camera so long as multiple captured images corresponding to the wavelengths of the light beams radiated from the first light source 241, the second light source 242, and the third light source 243 are acquirable.

An alternative example of the image capturing unit 250 may be a so-called three-plate color camera. In a three-plate color camera, the light from the sheets P irradiated with the light beams from the first light source 241, the second light source 242, and the third light source 243 is spectrally separated by a prism. Then, the spectrally-separated light beams are received by three imaging elements, so that captured images corresponding to the wavelengths of the light beams radiated from the first light source 241, the second light source 242, and the third light source 243 are acquired.

Another alternative example of the image capturing unit 250 may be a so-called vertically-separated color camera. A vertically-separated color camera has an imaging element in which a blue photoconductor that receives a blue light beam corresponding to the first light source 241, a green photoconductor that receives a green light beam corresponding to the second light source 242, and a red photoconductor that receives a red light beam corresponding to the third light source 243 are stacked. This imaging element decomposes the light from the sheets P in the stacking direction, so as to acquire multiple captured images corresponding to the wavelengths of the light beams radiated from the first light source 241, the second light source 242, and the third light source 243.

In the above exemplary embodiment, the light source 240 irradiates the sheets P separated from the sheet bundle Q with the blue light beam from the first light source 241, the green light beam from the second light source 242, and the red light beam from the third light source 243 as light beams having different wavelengths. Alternatively, the light beams radiated from the light source 240 are not limited to light beams of the three colors, namely, the blue, green, and red colors, so long as multiple captured images corresponding to the wavelengths of the light beams radiated from the light source 240 are acquirable in the image capturing unit 250. The light source 240 may irradiate the sheets P with light beams of two colors or may irradiate the sheets P with light beams of four or more colors as the light beams having different wavelengths.

Although the exemplary embodiment of the present disclosure has been described above, the technical scope of the disclosure is not limited to the scope defined in the above exemplary embodiment. It is obvious from the scope of the claims that exemplary embodiments obtained by adding various modifications and alterations to the above exemplary embodiment are included in the technical scope of the disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) A recording-medium container device comprising:
a container that contains a recording-medium bundle in which a plurality of recording media are stacked;
a blower that blows air onto the recording-medium bundle contained in the container;
a plurality of light sources that radiate light beams having different wavelengths simultaneously onto at least one of the recording media separated from the recording-medium bundle by the air blown by the blower; and
an image capturing unit that performs image-capturing of the at least one recording medium irradiated with the light beams from the plurality of light sources, so as to acquire a plurality of captured images corresponding to the wavelengths of the light beams radiated from the light sources.

(((2))) The recording-medium container device according to (((1))),
wherein each light source irradiates the at least one recording medium with light having a single peak wavelength in a spectral distribution.

(((3))) The recording-medium container device according to (((2))),
wherein the plurality of light sources include a red light source that radiates a red light beam having a peak wavelength within a range between 610 nm and 780 nm inclusive, a green light source that radiates a green light beam having a peak wavelength within a range between 500 nm and 570 nm inclusive, and a blue light source that radiates a blue light beam having a peak wavelength within a range between 460 nm and 500 nm inclusive, and
wherein the image capturing unit performs image-capturing of the at least one recording medium simultaneously irradiated with the red, green, and blue light beams, so as to acquire the captured images corresponding to red, green, and blue colors.

(((4))) The recording-medium container device according to (((3))),
wherein the image capturing unit includes a color filter including a red transmission section that transmits the red light beam, a green transmission section that transmits the green light beam, and a blue transmission section that transmits the blue light beam.

(((5))) The recording-medium container device according to any one of (((1))) to (((4))),
wherein the plurality of light sources are arranged in a stacking direction of the recording media and radiate the light beams toward a peripheral edge of the recording media.

(((6))) An image forming apparatus comprising:
the recording-medium container device according to any one of (((1))) to (((5)));
a transport unit that transports the at least one recording medium separated from the recording-medium bundle in the recording-medium container device; and
an image forming unit that forms an image onto the at least one recording medium transported by the transport unit.

(((7))) The image forming apparatus according to claim 6))), further comprising:
an adjuster that detects a position of an edge of the recording media in a stacking direction of the recording media by using the plurality of captured images acquired by the image capturing unit and that adjusts the air blown by the blower based on a detection result.

(((8))) The image forming apparatus according to (((7))),
wherein the adjuster detects the position of the edge based on one captured image in which the at least one recording medium has a smallest thickness, the one captured image being one of the plurality of captured images.

(((9))) The image forming apparatus according to (((7))),
wherein, if the position of the edge of the recording media is not detectable from one captured image of the plurality of captured images, the adjuster detects the position of the edge by using another captured image different from the one captured image.

What is claimed is:

1. A recording-medium container device comprising:
a container that contains a recording-medium bundle in which a plurality of recording media are stacked;
a blower that blows air onto the recording-medium bundle contained in the container;
a plurality of light sources that radiate light beams having different wavelengths simultaneously onto at least one of the recording media separated from the recording-medium bundle by the air blown by the blower; and
an image capturing unit that performs image-capturing of the at least one recording medium irradiated with the light beams from the plurality of light sources, so as to acquire a plurality of captured images corresponding to the wavelengths of the light beams radiated from the light sources.

2. The recording-medium container device according to claim 1,
wherein each light source irradiates the at least one recording medium with light having a single peak wavelength in a spectral distribution.

3. The recording-medium container device according to claim 2,
wherein the plurality of light sources include a red light source that radiates a red light beam having a peak wavelength within a range between 610 nm and 780 nm inclusive, a green light source that radiates a green light beam having a peak wavelength within a range between 500 nm and 570 nm inclusive, and a blue light source that radiates a blue light beam having a peak wavelength within a range between 460 nm and 500 nm inclusive, and
wherein the image capturing unit performs image-capturing of the at least one recording medium simultaneously irradiated with the red, green, and blue light beams, so as to acquire the captured images corresponding to red, green, and blue colors.

4. The recording-medium container device according to claim 3,
wherein the image capturing unit includes a color filter including a red transmission section that transmits the red light beam, a green transmission section that transmits the green light beam, and a blue transmission section that transmits the blue light beam.

5. The recording-medium container device according to claim 1,
wherein the plurality of light sources are arranged in a stacking direction of the recording media and radiate the light beams toward a peripheral edge of the recording media.

6. An image forming apparatus comprising:
the recording-medium container device according to claim 1;
a transport unit that transports the at least one recording medium separated from the recording-medium bundle in the recording-medium container device; and
an image forming unit that forms an image onto the at least one recording medium transported by the transport unit.

7. An image forming apparatus comprising:
the recording-medium container device according to claim 2;
a transport unit that transports the at least one recording medium separated from the recording-medium bundle in the recording-medium container device; and
an image forming unit that forms an image onto the at least one recording medium transported by the transport unit.

8. An image forming apparatus comprising:
the recording-medium container device according to claim 3;
a transport unit that transports the at least one recording medium separated from the recording-medium bundle in the recording-medium container device; and
an image forming unit that forms an image onto the at least one recording medium transported by the transport unit.

9. An image forming apparatus comprising:
the recording-medium container device according to claim 4;
a transport unit that transports the at least one recording medium separated from the recording-medium bundle in the recording-medium container device; and
an image forming unit that forms an image onto the at least one recording medium transported by the transport unit.

10. An image forming apparatus comprising:
the recording-medium container device according to claim 5;
a transport unit that transports the at least one recording medium separated from the recording-medium bundle in the recording-medium container device; and
an image forming unit that forms an image onto the at least one recording medium transported by the transport unit.

11. The image forming apparatus according to claim 6, further comprising:
an adjuster that detects a position of an edge of the recording media in a stacking direction of the recording media by using the plurality of captured images acquired by the image capturing unit and that adjusts the air blown by the blower based on a detection result.

12. The image forming apparatus according to claim 7, further comprising:
an adjuster that detects a position of an edge of the recording media in a stacking direction of the recording media by using the plurality of captured images acquired by the image capturing unit and that adjusts the air blown by the blower based on a detection result.

13. The image forming apparatus according to claim 8, further comprising:
an adjuster that detects a position of an edge of the recording media in a stacking direction of the recording media by using the plurality of captured images acquired by the image capturing unit and that adjusts the air blown by the blower based on a detection result.

14. The image forming apparatus according to claim 9,
an adjuster that detects a position of an edge of the recording media in a stacking direction of the recording media by using the plurality of captured images acquired by the image capturing unit and that adjusts the air blown by the blower based on a detection result.

15. The image forming apparatus according to claim 10,
an adjuster that detects a position of an edge of the recording media in the stacking direction of the recording media by using the plurality of captured images acquired by the image capturing unit and that adjusts the air blown by the blower based on a detection result.

16. The image forming apparatus according to claim 11,
wherein the adjuster detects the position of the edge based on one captured image in which the at least one recording medium has a smallest thickness, the one captured image being one of the plurality of captured images.

17. The image forming apparatus according to claim 12,
wherein the adjuster detects the position of the edge based on one captured image in which the at least one recording medium has a smallest thickness, the one captured image being one of the plurality of captured images.

18. The image forming apparatus according to claim 13,
wherein the adjuster detects the position of the edge based on one captured image in which the at least one recording medium has a smallest thickness, the one captured image being one of the plurality of captured images.

19. The image forming apparatus according to claim 14,
wherein the adjuster detects the position of the edge based on one captured image in which the at least one recording medium has a smallest thickness, the one captured image being one of the plurality of captured images.

20. The image forming apparatus according to claim 11,
wherein, if the position of the edge of the recording media is not detectable from one captured image of the plurality of captured images, the adjuster detects the position of the edge by using another captured image different from the one captured image.
